(19) United States
(12) Patent Application Publication
(10) Pub. No.: US 2024/0070463 A1
(43) Pub. Date: Feb. 29, 2024

(54) INFORMATION PROCESSING DEVICE AND NEURAL NETWORK COMPRESSION METHOD

(71) Applicant: Hitachi Astemo, Ltd., Hitachinaka-shi, Ibaraki (JP)

(72) Inventors: Daichi MURATA, Tokyo (JP); Akira KITAYAMA, Tokyo (JP); Hiroaki ITO, Hitachinaka-shi (JP); Masayoshi KURODA, Hitachinaka-shi (JP)

(73) Assignee: Hitachi Astemo, Ltd., Hitachinaka-shi, Ibaraki (JP)

(21) Appl. No.: 18/035,868

(22) PCT Filed: Sep. 22, 2021
(86) PCT No.: PCT/JP2021/034898

§ 371 Date: May 8, 2023

(30) Foreign Application Priority Data
Nov. 11, 2020 (JP) 2020-188356

(51) Int. Cl. G06N 3/082

(52) U.S. Cl. CPC G06N 3/082; G01S 7/4802

(57) ABSTRACT

Optimization of a compression algorithm to be applied is realized in subgraph units of a neural network. A preferred aspect of the present invention is an information processing device that selects an algorithm for compressing a neural network. The information processing device includes a subgraph dividing section which divides the neural network into subgraphs and an optimizing section which outputs a compression configuration in which one compression technique selected from a plurality thereof is associated with each of the subgraphs.

### TECHNICAL FIELD

The present invention relates to compression of a neural network.

### BACKGROUND ART

In recent years, there is accelerating movement toward realizing high-level automatic driving using highly accurate object recognition and behavior prediction by implementing a deep neural network (DNN) on an in-vehicle electronic control unit (ECU).

As illustrated in FIG. 1, a DNN is realized by connecting one or more computing layers including a large number of neurons in multiple stages. In an Nth computing layer, a value output from an (N−1)th layer is used as an input, and a result obtained by weighting the input value with a weighting factor is output to an input of an (N+1)th layer. At this time, high generalization performance can be obtained by setting (training) the weighting factor to an appropriate value according to an application.

Examples of a DNN for automatic driving include point cloud artificial intelligence (AI) which uses a Light Detection and Ranging or Laser Imaging Detection and Ranging (LiDAR) point cloud to realize object recognition, segmentation, and the like.

PTL 1 discloses a method for reducing (compressing) computation of a neural network represented by a DNN.

### CITATION LIST

### Patent Literature

PTL 1: US 2018/046919 A1

### SUMMARY OF INVENTION

### Technical Problem

FIG. 2 illustrates a configuration example of point cloud AI. A voxel (volume element) is allocated to a LiDAR point cloud, and a simulated image is generated by a DNN or the like. A predetermined object in the simulated image is detected by a convolutional neural network (CNN).

In order to apply the point cloud AI to automatic driving, it is necessary to improve the performance of the point cloud AI by using high-resolution LiDAR. Therefore, implementing the point cloud AI for automatic driving requires an enormous amount of computation as compared with the computing performance of an in-vehicle processor. For example, computation of at least 65 giga operations (GOPs) is required in order to realize object recognition in automatic driving using PointPillars, which is a type of point cloud AI. Conversely, the computing performance of a processor that can be mounted on an in-vehicle ECU is approximately several tens of tera operations per second (TOPS), and is insufficient for executing an entire automatic driving system including PointPillars in real time.

Therefore, there is a need for a computation reduction (compression) algorithm capable of both reducing the computation of the point cloud AI for automatic driving and maintaining high inference accuracy.

In the technique described in PTL 1, in order to reduce the computation of a neural network represented by a DNN, compression of the DNN is realized by a multi-iteration compression method.

FIG. 3 is a diagram created by the inventors, and illustrates an example in which a single arbitrary compression algorithm is uniformly applied to an entire compression target DNN in a DNN compression flow.

For a training data set 301 and a precompression DNN model 302, for example, an initial compression condition is determined by selecting from preset compression conditions (S303). It is assumed that the precompression DNN model 302 has been trained with the training data set 301.

Next, the precompression DNN model 302 is compressed based on a compression position in the DNN and a compression rate based on the initial compression condition (S304).

Next, the compressed DNN model is retrained with the training data set 301 (S305), and it is determined whether to end the compression by evaluating an error in the output of the DNN model before and after compression (S306). When the compression is completed, the compressed DNN model is recorded as a compressed DNN model 307.

When the compression is not completed, optimal conditions of the compression position and the compression rate are searched for (S308), and the compression is performed again (S304).

However, in a DNN with a complicated structure such as point cloud AI, an optimal compression algorithm is different for each part (subgraph) constituting the DNN. Therefore, it is necessary to select and apply an optimal compression algorithm in subgraph units in order to realize high accuracy compression that achieves both computation reduction of the DNN and maintenance of inference accuracy.

As such, in the above configuration, there is a problem that optimization of the compression algorithm to be applied cannot be realized in subgraph units of the neural network.

### Solution to Problem

A preferred aspect of the present invention is an information processing device that selects an algorithm for compressing a neural network. The information processing device includes a subgraph dividing section which divides the neural network into subgraphs and an optimizing section which outputs a compression configuration in which one compression technique selected from a plurality thereof is associated with each of the subgraphs.

Another preferred aspect of the present invention is a neural network compression method including a first step of dividing a neural network into subgraphs and a second step of performing tentative compression by associating one compression technique selected from a plurality thereof with each of the subgraphs.

### Advantageous Effects of Invention

Optimization of the compression algorithm to be applied can be realized in subgraph units of the neural network.

### BRIEF DESCRIPTION OF DRAWINGS

FIG. 1 is a conceptual diagram illustrating a structure of a deep neural network (DNN).

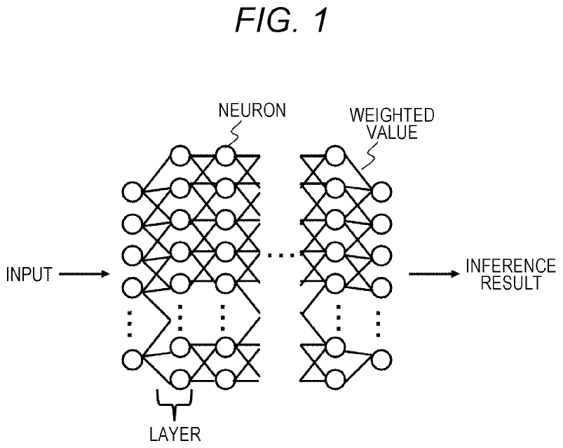

FIG. 2 is a conceptual diagram illustrating a configuration example of point cloud AI.

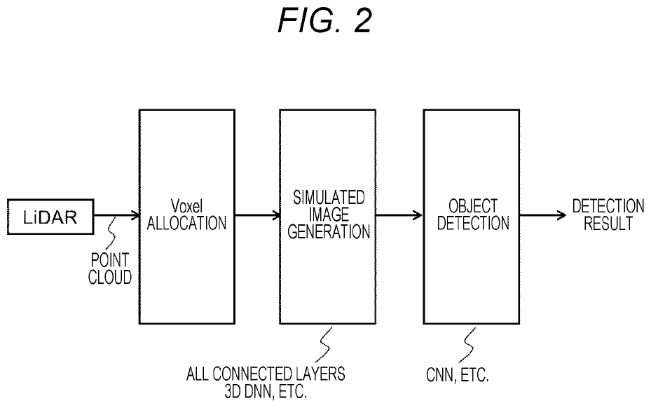

FIG. 3 is a DNN compression flowchart (comparative example).

FIG. 4 is a DNN compression flowchart (embodiments).

FIG. 5 is a schematic processing diagram of a compression algorithm optimizing section.

FIG. 6 is a graph illustrating an effect of the embodiments.

FIG. 7 is a block diagram of a first embodiment/a first basic configuration.

FIG. 8A is a block diagram of a second embodiment/a second basic configuration (overall configuration).

FIG. 8B is a table illustrating an example of a compression configuration.

FIG. 9 is a processing flowchart of a second embodiment/a second basic configuration (compression algorithm optimizing section).

FIG. 10 is a configuration diagram of the second embodiment/the second basic configuration (compression algorithm optimizing section).

FIG. 11A is a processing flowchart of the second embodiment/the second basic configuration (subgraph dividing section).

FIG. 11B is a conceptual diagram of subgraph division.

FIG. 12 is a configuration diagram of the second embodiment/the second basic configuration (perturbation calculating section 1).

FIG. 13 is a configuration diagram of the second embodiment/the second basic configuration (perturbation calculating section 2).

FIG. 14 is a configuration diagram of the second embodiment/the second basic configuration (compressing section).

FIG. 15 is an overall configuration diagram of a third embodiment/a first application configuration.

FIG. 16 is an overall configuration diagram of a fourth embodiment/a second application configuration.

FIG. 17 is an overall configuration diagram of a fifth embodiment/a third application configuration.

### DESCRIPTION OF EMBODIMENTS

The following describes embodiments with reference to the accompanying drawings. However, the present invention is not to be construed as being limited to the description of the embodiments indicated in the following. Those skilled in the relevant art should easily be able to understand that the specific configuration can be changed within a scope not departing from the spirit or gist of the present invention.

In the configurations of the embodiments described below, the same reference numerals are commonly used for the same parts or parts having similar functions in different drawings, and redundant description may be omitted.

In a case where there is a plurality of elements having the same or similar functions, the same reference numerals may be appended with different subscripts for description. However, in a case where it is not necessary to distinguish between a plurality of elements, description may be omitted.

Notations such as “first”, “second”, and “third” in the present specification and the like are appended to identify constituent elements, and do not necessarily limit the number, order, or contents thereof. In addition, a number for identifying a constituent element is used for each context, and a number used in one context does not necessarily indicate the same configuration in another context. Furthermore, a constituent element identified by a certain number is not prevented from also functioning as a constituent element identified by another number.

Aspects such as position, size, shape, and range of the respective components illustrated in the drawings and the like may not represent actual aspects such as position, size, shape, and range thereof in order to facilitate understanding of the invention. Therefore, the present invention is not necessarily limited to aspects such as the position, size, shape, and range disclosed in the drawings and the like.

The publications, patents, and patent applications cited in the present specification constitute a part of the description of the present specification as-is.

Constituent elements expressed in the singular in the present specification are intended to include the plural unless the context clearly dictates otherwise.

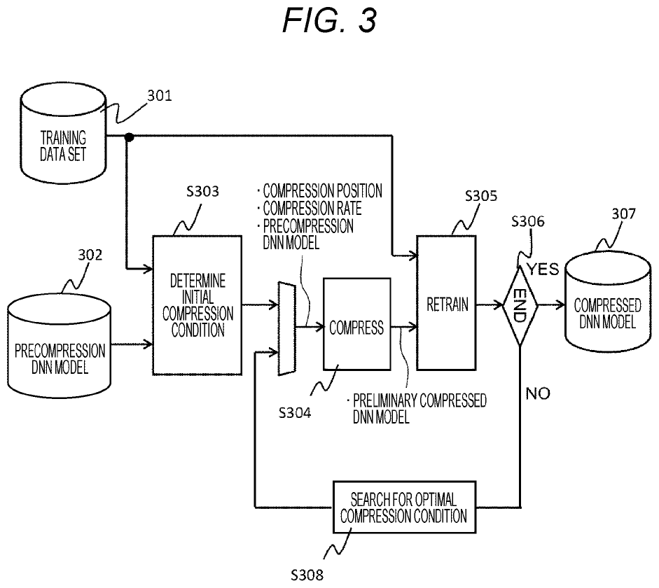

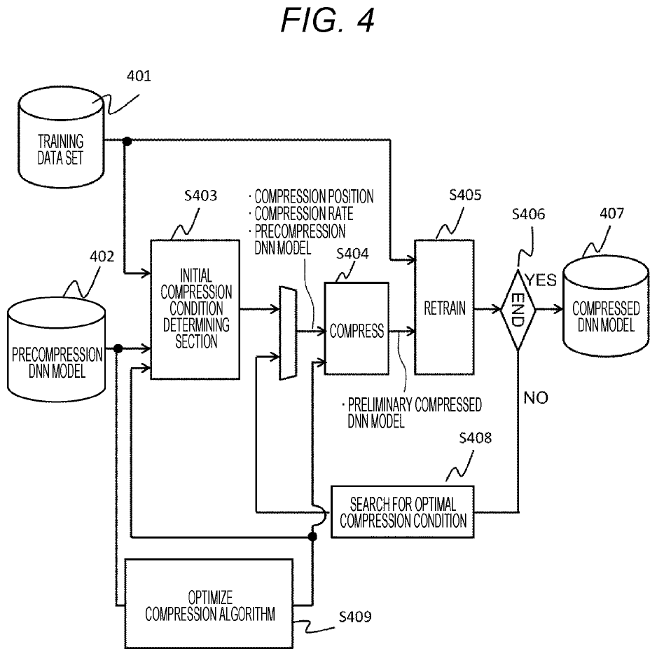

FIG. 4 illustrates a flow of an example of the embodiments. Compression algorithm optimization processing (S409) is provided for the compression flow of FIG. 3.

In the compression algorithm optimization (S409), a precompression DNN model 402 is first divided into a plurality of subgraphs, and an optimal compression algorithm is searched for with high efficiency in subgraphs units.

For a training data set 401 and the precompression DNN model 402, for example, an initial compression condition is determined for each subgraph by selecting from preset compression conditions (S403). It is assumed that the precompression DNN model 402 has been trained with the training data set 401.

Next, the precompression DNN model 402 is compressed in each subgraph based on a compression position in the DNN and a compression rate based on the initial compression condition (S404).

Next, the compressed DNN model is retrained with the training data set 401 (S405), and it is determined whether to end the compression by performing such actions as evaluating an error in the output of the DNN model before and after compression (S406). When the compression is completed, the compressed DNN model is recorded as a compressed DNN model 407.

Here, since detection accuracy decreases due to compression, retraining is performed to recover the detection accuracy. When retraining is not performed, there is a possibility that the detection rate of the compressed AI is greatly reduced. In retraining, basically, the same data set as that used for training of the precompression DNN model may be used, but the data set can be flexibly changed according to an application scene or the like.

When compression is not ended, optimal conditions of the compression position and the compression rate are searched for (S408), and compression is performed again (S404).

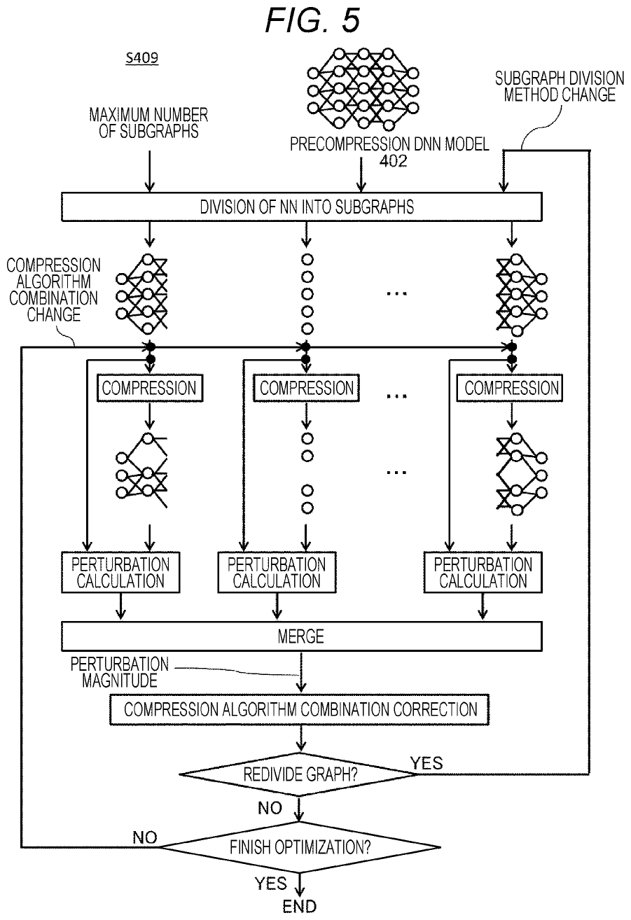

FIG. 5 schematically illustrates processing of the compression algorithm optimization (S409). First, an initial value of a subgraph division position is determined on the basis of an input maximum number of subgraphs and the precompression DNN model 402. The maximum number of subgraphs may be set in advance or specified by a user each time. The division positions are divided according to a predetermined rule, for example, such that the number of neurons is as equal as possible.

Next, the compression algorithm is applied to each of the divided subgraphs, and an error absolute value of the calculation result of each subgraph before and after the application of compression is output as the magnitude of a perturbation. The compression algorithm is selected from, for example, a plurality of previously prepared algorithms. Different compression algorithms can be selected for each subgraph.

The perturbation calculation results are merged and comprehensively evaluated. Next, using an arbitrary optimization algorithm, a combination of compression algorithms to be applied to each subgraph is changed so that the magnitude of the evaluated perturbation becomes small. At this time, in a case where the magnitude of the perturbation does not converge to less than a certain threshold even though the combination of compression algorithms is changed an arbitrary number of times, the subgraph division position of the precompression DNN model 402 is changed, and combination optimization of the compression algorithms is performed again.

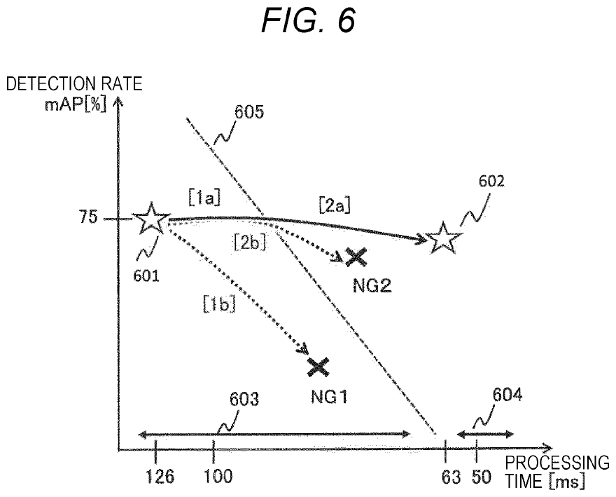

FIG. 6 illustrates an effect in a case where the present embodiments are applied to PointPillars which is point cloud AI for object recognition. When a single compression technique 1b (reduction in the number of voxels) is applied to the entire DNN model of a precompression point cloud AI 601, the detection rate significantly decreases as NG1. In addition, when a single compression technique 2b (low rank approximation) is applied to the entire DNN model, the processing time is shortened as NG2, but the detection rate decreases.

In the present embodiment, a compression technique 1a (reduction in the number of point clouds per voxel) is applied to a subgraph 1 of the DNN model of the precompression point cloud AI 601, and a compression technique 2a (pruning) is applied to a subgraph 2. As a result, an optimally compressed point cloud AI 602 is obtained.

Note that an arrow 603 indicates a limit value of the detection rate and the processing time obtained by the compression technique 1a for the subgraph 1, and an arrow 604 indicates a limit value of the detection rate and the processing time obtained by the compression technique 2a for the subgraph 2. An oblique dotted line 605 indicates these boundaries. As described above, it can be understood that there is a compression technique suitable for each subgraph.

The optimally compressed point cloud AI 602 of the present embodiments can reduce inference time by 50% while suppressing a decrease in the detection rate due to the compression of PointPillars. Note that the present embodiments can be applied not only to point cloud AI but also to other AI such as an image processing CNN.

### First Embodiment

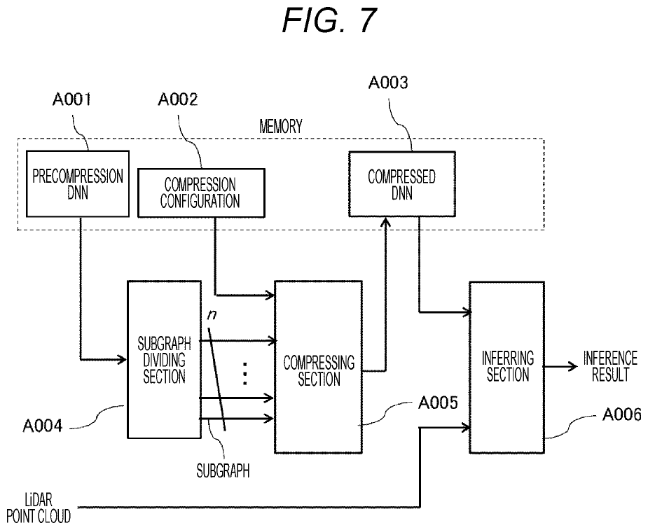

FIG. 7 illustrates a configuration diagram of a first embodiment. First, a precompression DNN (A001) read from memory is received as an input, and the precompression DNN is divided into n subgraphs in a subgraph dividing section (A004). Next, the n subgraphs and a compression configuration (A002) read from the memory are received as inputs, and compression is applied to each subgraph in a compressing section (A005). Subgraphs to which the compression is applied are recombined and stored in the memory as a compressed DNN (A003). Finally, the compressed DNN (A003) and a LiDAR point cloud read from the memory are received as inputs, and an inferring section (A006) performs inference of the DNN and outputs an inference result.

### Second Embodiment

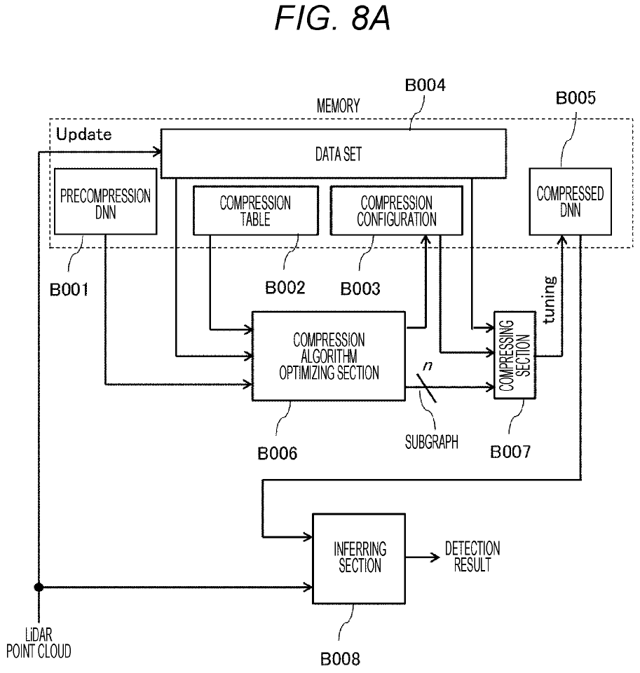

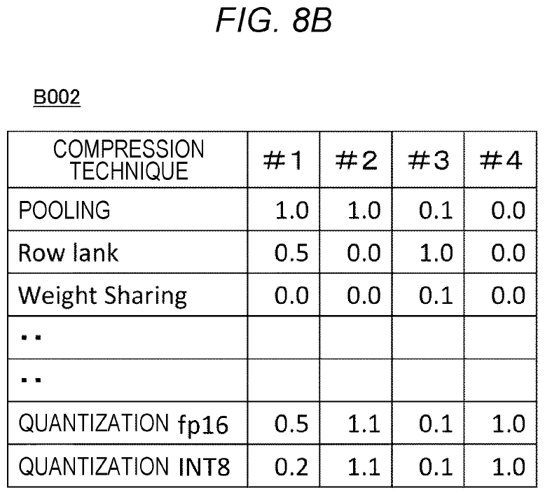

FIG. 8A illustrates a configuration diagram of a second embodiment. First, a precompression DNN (B001) and a data set (B004) read from memory and a compression table (B002) in which applicable contraction algorithms are described are input to a compression algorithm optimizing section (B006), and contraction algorithms applied to the precompression DNN are optimized in units of subgraphs. Here, the correspondence relationship between each subgraph and an optimal compression algorithm is written in a compression configuration (B003) and held in the memory. Note that the data set (B004) held in the memory is assumed to be appropriately updated by LiDAR point cloud data acquired from a sensor.

Next, by inputting the compression configuration (B003), the data set (B004), and n subgraphs to a compressing section (B007), a compressed DNN (B005) is generated and stored in the memory. Finally, the compressed DNN (B005) and the LiDAR point cloud are input to an inferring section (B008) to obtain an inference result. According to the present embodiment, it is possible to dynamically adjust the DNN compression technique according to a change in a traveling scene or the like.

The system configuration of FIG. 8A can be configured by a general information processing device such as a server. An information storage device includes a processing device, a storage device, an input device, and an output device. In the present embodiment, functions such as calculation and control are realized by a processing device executing a program stored in the storage device in cooperation with other hardware to perform established processing. A program executed by a computer or the like, a function thereof, or a means for realizing the function may be referred to as a “function”, a “means”, a “section”, a “unit”, a “module”, or the like.

In FIG. 8A, for the sake of explanation, naturally included configurations of the above server are omitted and displayed in the form of data or functional blocks. The LiDAR point cloud data is input from the input device, for example. The precompression DNN (B001), the data set (B004), and the compression table (B002) are stored as a database in a component such as a hard disk device that is a part of the storage device (memory), and are appropriately called and used in a component such as semiconductor memory that is also a part of the storage device. The compression algorithm optimizing section (B006) and the compressing section (B007) are implemented as programs in the storage device, and are executed by the processing device to realize predetermined functions. The processing result is stored in the compression configuration (B003) and the compressed DNN (B005).

The inferring section (B008) is a device for executing processing of AI, and is commercially available as a module capable of implementing a neural network. Known examples of the module include Versal (registered trademark), Xavier (registered trademark), and NCS2 (trade name).

The above-described server configuration may be configured by a single device, or may be configured by another computer to which by any part of the input device, the output device, the processing device, or the storage device is connected via a network.

In the present embodiment, a function equivalent to a function configured by software can also be realized by hardware such as a field programmable gate array (FPGA) or an application specific integrated circuit (ASIC).

FIG. 8B is a table illustrating an example of the compression table (B002). A compatibility with each compression technique is recorded for devices #1, #2, #3, and #4 registered as devices applicable to the inferring section (B008). The value of compatibility is in a range of 1 to 0, with compatibility close to 1 being high. These pieces of information are registered in advance as a database according to public information or knowledge of the user.

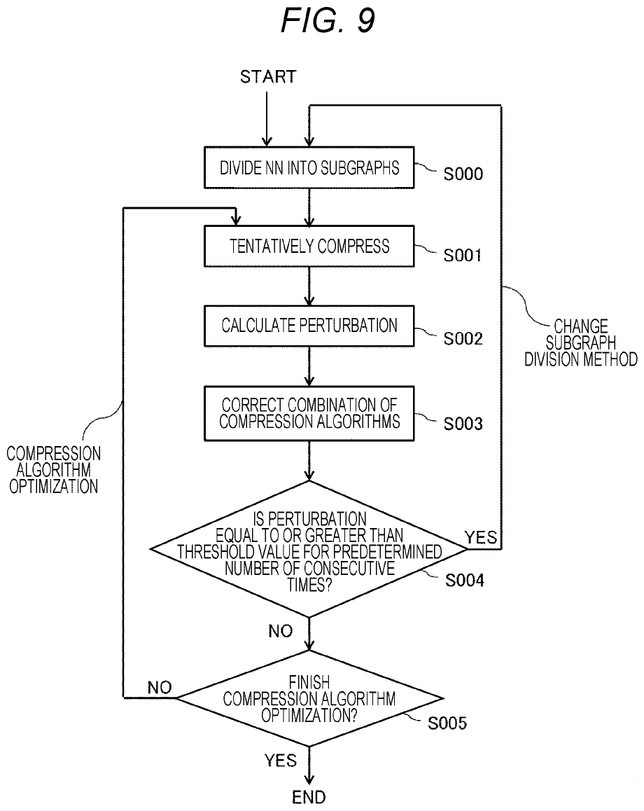

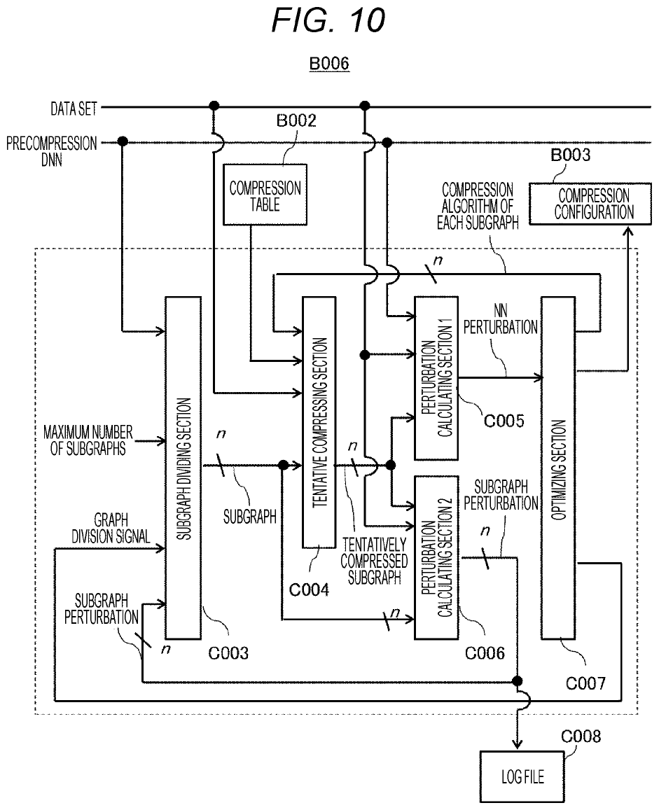

Hereinafter, the configuration and the processing flow of the compression algorithm optimizing section (B006) in FIG. 8A will be described in detail. FIG. 9 illustrates the processing flow, and FIG. 10 illustrates the device configuration.

The flow of FIG. 9 will be sequentially described.

S000: The precompression DNN, a subgraph perturbation output from a perturbation calculating section 2 (C006), a maximum number of subgraphs that is the upper limit of a number of divisions into subgraphs, and a graph division signal output from an optimizing section (C007) are input to a subgraph dividing section (C003), and the precompression DNN is divided into n subgraphs. The maximum number of subgraphs may be preset or specified by the user each time.

S001: A compression algorithm for each subgraph output by the subgraphs, the compression table (B002), and the optimizing section (C007) is input to a tentative compressing section (C004), and the compression algorithms corresponding to respective subgraphs are applied to generate tentatively compressed subgraphs. As illustrated in FIG. 8B, it is assumed that known compression algorithms such as pooling, row lank, weight sharing, and quantization are registered in the compression table (B002). In the selection of the compression algorithms, for example, in the compression table (B002), compression algorithms having high compatibility with the implementation devices are preferentially selected.

S002: The precompression DNN, the data set, and the tentatively compressed subgraphs are input to a perturbation calculating section 1 (C005) and the perturbation calculating section 2 (C006), and perturbations of calculation results before and after compression are generated as an NN perturbation and a subgraph perturbation, respectively. Here, the subgraph perturbation is recorded as a log file (C008) in the memory.

S003: By inputting the NN perturbation to the optimizing section (C007), the combination of compression algorithms is corrected so that the value of the NN perturbation becomes small. In the search for the combination, for example, combinations of algorithms with high compatibility in the compression table B002 are comprehensively tried, and loop processing of the compression algorithm optimization is performed.

S004: In a case where the NN perturbation is equal to or larger than an arbitrary threshold value for predetermined consecutive k times during a trial of the optimizing section (C007), the graph division signal is enabled and the processing returns to S000. Otherwise, the processing proceeds to S005.

S005: The end of the optimization is determined according to a predetermined end condition. The end condition includes items such as that the NN perturbation satisfies a predetermined condition and that a limit time or a limit number of times of processing is exceeded. When the optimization of the compression algorithms is continued, the processing returns to S001. Otherwise, the processing is completed.

Next, the subgraph dividing section (C003) will be described.

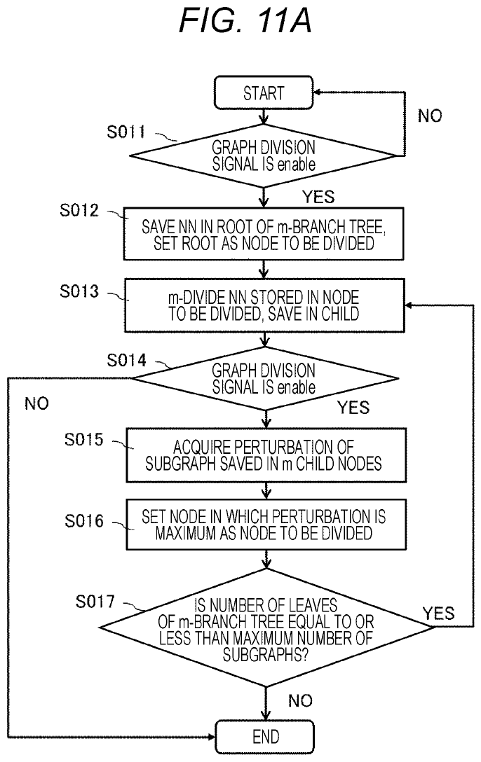

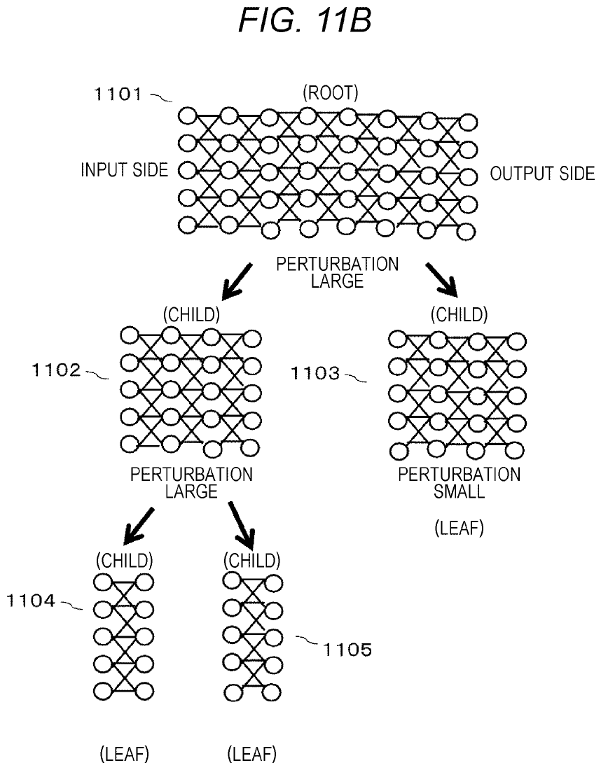

FIG. 11A illustrates a processing flow of the subgraph dividing section. This will be described together with FIG. 9.

FIG. 11B illustrates a concept of divided subgraphs.

The subgraph dividing section (C003) is normally in a standby state, and is activated when the graph division signal has been enabled (S004). Since the subgraph perturbation and the graph division signal are not applied immediately after the start of the compression processing of the AI, the AI is not divided (i.e., the number of subgraphs n=1), and the same compression technique is applied to the entire AI (001). The optimal compression technique to be applied is selected by the tentative compressing section (C004) with reference to the compression table (B002). The perturbation calculating section 1 (C005) calculates a perturbation value of an inference result caused by compression for the entire AI (S002). At this time, since the subgraph=the precompression DNN, the perturbation calculating section 2 (C006) outputs the same perturbation value as the perturbation calculating section 1 (C005). The combination of compression algorithms is corrected (S003), and when the end condition is satisfied, it is not necessary to divide the AI, so the compression processing ends (S005). In a case where the NN perturbation is equal to or greater than the threshold value for a predetermined number of consecutive times even if the combination of the compression algorithms is corrected, the graph division signal is enabled, and the processing proceeds to S012 (S000) (S004).

S012: The precompression DNN (graph 1101 in FIG. 11B) is stored in the root of an m-branch tree, and the root of the m-branch tree is set as a division target node. The value of m may be preset or may be input by the user each time. In this example, the value is described as a fixed value of m=2. The precompression DNN in FIG. 11B is 8 layers in this example.

S013: The graph stored in the division target node is divided into m, and stored in m child nodes under the division target node. In the example of FIG. 11B, the graph 1101 is divided into m=2, and the graphs 1102 and 1103 are child nodes. The division method divides the graphs so as to be as uniform as possible in units of layers. In this example, a graph of each of four layers becomes a subgraph. In this state, the subgraphs 1102 and 1103 after the division are stored in m respective leaf nodes (leaf nodes of depth 1: m) of the m-branch tree.

S014: The tentative compressing section (C004) applies a compression technique for each subgraph after the division (S001), and the perturbation calculating section 1 (C005) calculates a perturbation value of an inference result caused by compression for the entire AI (S002). The compression algorithms are corrected (S003). In a case where the NN perturbation is greater than the threshold value due to compression, the graph division signal is enabled and the processing proceeds to S015 (S004). In a case where the NN perturbation is smaller than the threshold value, it is determined that the effect of the graph division has been obtained, and the processing ends (S005).

S015: For each of the subgraphs stored in the m child nodes, the perturbation calculating section 2 (C006) acquires a value of the subgraph perturbation (S002). In the example of FIG. 11B, perturbation of subgraphs 1102 and 1103 is calculated.

S016: Among the m child nodes, a child node with the largest absolute value of the subgraph perturbation is set as a new division target node. In the example of FIG. 11B, it is assumed that the perturbation of the subgraph 1102 is large, and the subgraph 1102 is a division target node.

S017: When the number of leaves of the generated m-branch tree is equal to or less than the maximum number of subgraphs, the processing returns to S013. Otherwise, the processing is ended. In the example of FIG. 11B, the subgraphs 1102 and 1103 being divided results in leaves. Therefore, if the number 2 of leaves exceeds the maximum number of subgraphs, the division is ended. Otherwise, the processing returns to S013.

S013: The graph of the division target node (the subgraph 1102 in this example) is a division target and is divided into m=2. The divided subgraphs 1104 and 1105 are stored in respective m children of the division target node. In this state, each subgraph stored in 2m−1 leaf nodes (leaf nodes of depth 1: m−1+m leaf nodes of depth 2) of the m-branch tree are divided subgraphs. In this example, a leaf node of depth 1 is the subgraph 1103, and leaf nodes of depth 2 are the subgraphs 1104 and 1105. The number of these leaf nodes (3 in the example of FIG. 11B) is equal to the number n of subgraphs.

S014: The tentative compressing section (C004) applies a compression technique to each 2m −1 subgraph, and the perturbation calculating section 1 (C005) calculates a perturbation value of an inference result caused by compression for the entire AI. The compression algorithms are corrected (S003). In a case where the value of the NN perturbation due to compression is greater than the threshold value, the subgraph division signal is enabled and the division is repeated (S004). The next division target is a graph having the largest subgraph perturbation among the subgraphs 1103, 1104, and 1105.

The end condition of the loop is a case where a division number n of the subgraphs (the number of leaf nodes of the m-branch tree) exceeds a maximum value (S017).

Next, the perturbation calculating section 1 (C005) will be described. The perturbation calculating section 1 (C005) calculates the NN perturbation of the entire network model. The NN perturbation is used to search for an optimal combination of compression techniques.

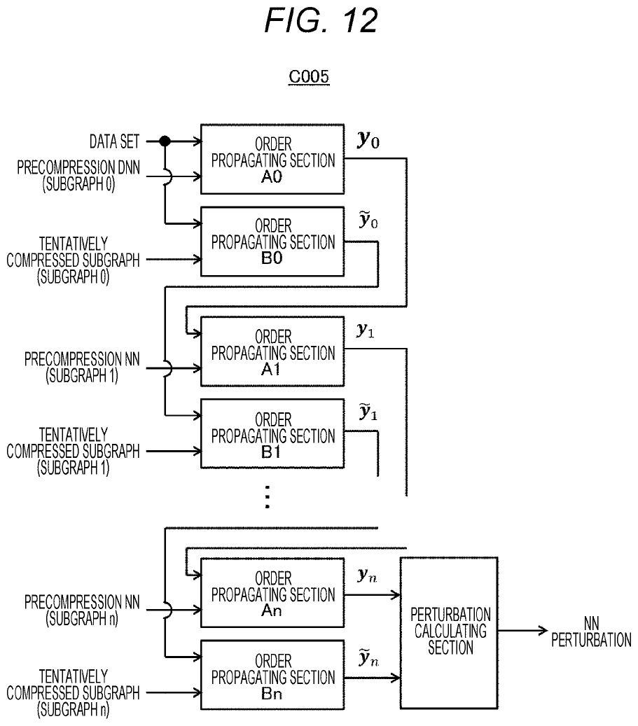

FIG. 12 illustrates a configuration diagram. First, a 0th tentatively compressed subgraph and a corresponding subgraph of the precompression DNN are respectively input to a forward feeding section BC and a forward feeding section A0, and the same data set is fed forward. Similarly, a kth tentatively compressed subgraph and a corresponding subgraph of the precompression DNN are respectively input to a forward feeding section Bk and a forward feeding section Ak, and the computing result of a k−1st forward feeding section Bk−1 and the computing result of a forward feeding section Ak−1 are fed forward. The above operation is repeated up to the nth subgraph, and the absolute value of the difference between the computing results of the forward feeding sections An and Bn is calculated by a perturbation calculating section to generate the NN perturbation.

Next, the perturbation calculating section 2 (C006) will be described. The perturbation calculating section 2 (C006) calculates a subgraph perturbation for each subgraph. The subgraph perturbation is used for determining necessity of subgraph division of the network.

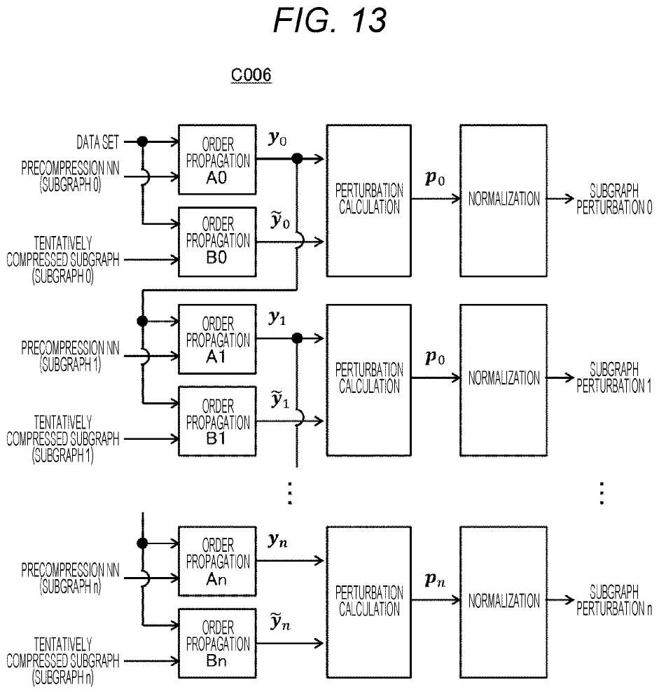

FIG. 13 illustrates a configuration diagram. First, a 0th tentatively compressed subgraph and a corresponding subgraph of the precompression DNN are respectively input to a forward feeding section BC and a forward feeding section A0, and the same data set is fed forward. Similarly, the kth tentatively compressed subgraph and the corresponding subgraph of the precompression DNN are respectively input to the forward feeding section Bk and the forward feeding section Ak, and the computing result of the (k−1)th forward feeding section Ak−1 is fed forward to both. The above operation is repeated up to the nth subgraph. At this time, a value obtained by applying normalization to the absolute value of the difference between the computing results of the forward feeding sections Ak and Bk is generated as a subgraph perturbation k. The normalization can be performed, for example, by computing (perturbation pᵢ/output yᵢ of precompression NN). Finally, the compressing section (B007) will be described.

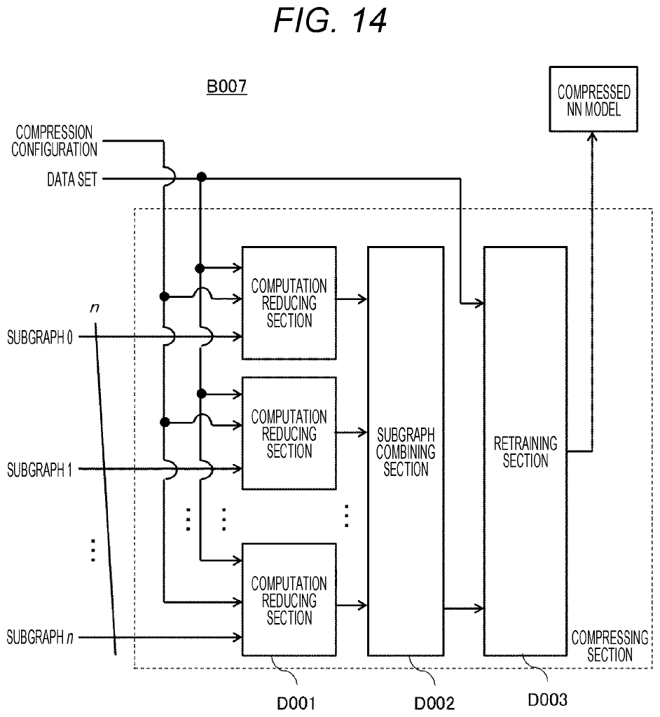

FIG. 14 illustrates a configuration diagram. First, n subgraphs and a compression configuration describing compression algorithms applied to each subgraph are received as inputs, and compression is executed in a computation reducing section (D001). Next, the compression results for each subgraph are recombined into one DNN in a subgraph combining section (D002). Retraining is executed in a retraining section (D003) using the recombined DNN and a data set to generate a compressed NN model.

### Third Embodiment

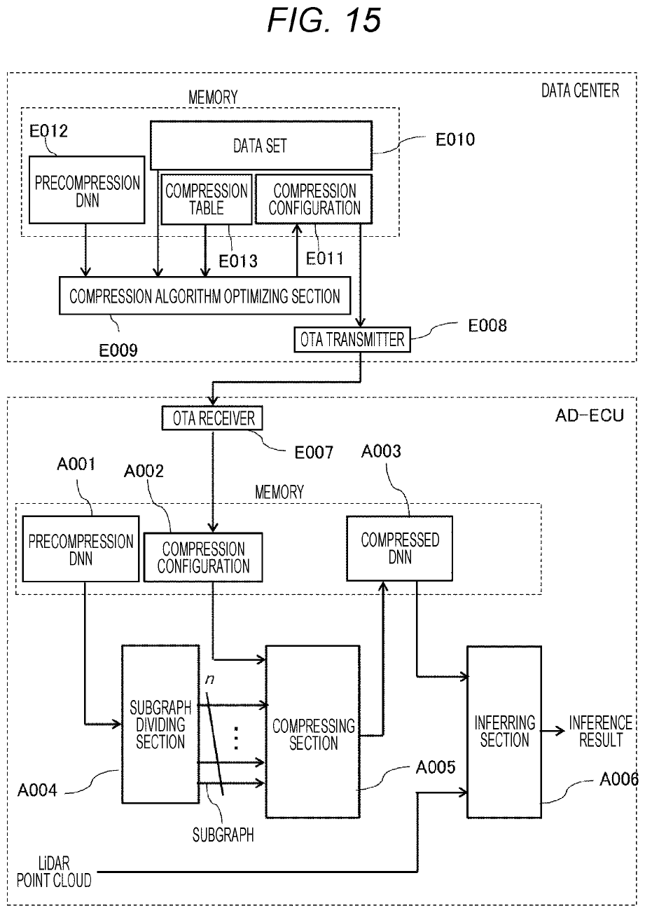

FIG. 15 illustrates a configuration of a third embodiment. The third embodiment has a configuration in which a system for generating a compression configuration on a data center side is added to the first embodiment. Specifically, a compression configuration (E011) is generated by a compression algorithm optimizing section (E009) using a precompression DNN (E012), a data set (E010), and a compression table (E013) on the data center side, and a compression configuration (E002) on an AD-ECU side is updated via an OTA transmitter (E008) and an OTA receiver (E007).

### Fourth Embodiment

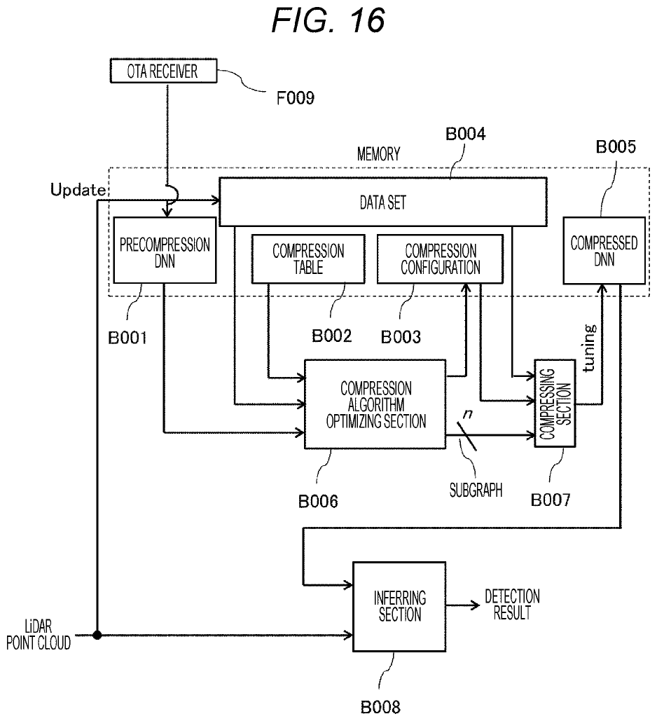

FIG. 16 illustrates a configuration of a fourth embodiment. The fourth embodiment has a configuration in which a precompression DNN can be received from the outside by an OTA receiver (F009) as compared with the second embodiment.

### Fifth Embodiment

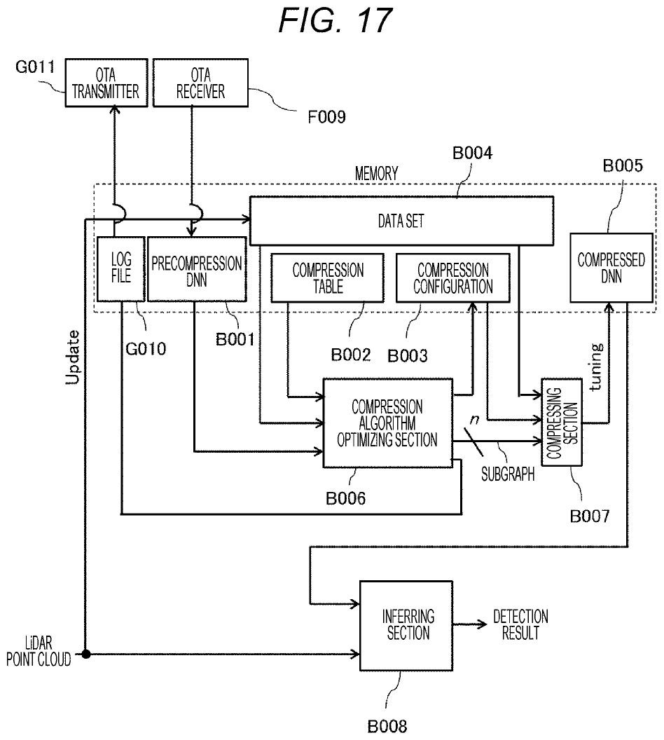

FIG. 17 illustrates a configuration of a fifth embodiment. The fifth embodiment has a configuration in which a perturbation log (G010) acquired by a compression algorithm optimizing section is stored in memory and can be transmitted to the outside through an OTA transmitter (G011) as compared with the fourth embodiment.

### REFERENCE SIGNS LIST

A001, B001, E001, E012, F001, G001 precompression DNN
A002, B003, C002, E002, E011, F003, G003 compression configuration
A003, B005, E003, F005, G005 compressed DNN
A004, C003, E004 subgraph dividing section
A005, B007, E005, F007, G007 compressing section
A006, B008, E006, F008, G008 inferring section
B002, C001, E013, F002, G002 compression table
B004, E010, F004, G004 data set
B006, E009, F006, G006 compression algorithm optimizing section
C004 tentative compressing section
C005 perturbation calculating section 1
C006 perturbation calculating section 2
C007 optimizing section
C008, G010 log file
D001 computation reducing section
D002 subgraph combining section
D003 retraining section
E007, F009, G009 OTA receiver
E008, G011 OTA transmitter

1. An information processing device that selects an algorithm for compressing a neural network, the information processing device comprising:
a subgraph dividing section which divides the neural network into subgraphs; and
an optimizing section which outputs a compression configuration in which one compression technique selected from a plurality thereof is associated with each of the subgraphs.

2. The information processing device according to claim 1, wherein the subgraph dividing section divides the neural network having a hierarchical structure in units of layers.

3. The information processing device according to claim 2, further comprising:
a tentative compressing section; and
a first perturbation calculating section, wherein
the tentative compressing section outputs tentatively compressed subgraphs by compressing the subgraphs respectively associated with one compressing technique selected from a plurality thereof,
the first perturbation calculating section outputs a perturbation of the neural network based on a difference between a forward feeding value of the neural network and a forward feeding value obtained by combining a plurality of the tentatively compressed subgraphs in series, and
the optimizing section outputs a compression configuration in which the perturbation of the neural network satisfies a predetermined value.

4. The information processing device according to claim 3, wherein the tentative compressing section refers to a compression table in which a type of a device on which the neural network is to be implemented and priority of compression techniques to be applied are associated with each other, and selects one compression method from a plurality thereof.

5. The information processing device according to claim 3, further comprising a second perturbation calculating section, wherein
the second perturbation calculating section outputs a perturbation of each of the subgraphs based on a difference between a forward feeding value of each of the subgraphs and a forward feeding value of each of the tentatively compressed subgraphs, and
the subgraph dividing section selects a subgraph to be further divided based on perturbation of the subgraphs.

6. The information processing device according to claim 5, wherein the subgraph dividing section selects a subgraph with a presently largest perturbation as a subgraph to be further divided.

7. The information processing device according to claim 1, further comprising a compressing section, wherein
the compressing section includes a computation reducing section and a subgraph combining section,
the computation reducing section receives the subgraphs and the compression configuration as inputs, applies a compression technique described in the compression configuration to each of the subgraphs, and outputs compressed subgraphs, and
the subgraph combining section receives an output of the computation reducing section as an input, combines the compressed subgraphs, and outputs a compressed neural network.

8. The information processing device according to claim 7, further comprising a retraining section, wherein
the retraining section receives the compressed neural network and a training data set, and trains the compressed neural network.

9. The information processing device according to claim 5, wherein the perturbation of the subgraphs is held in memory as a perturbation log.

10. The information processing device according to claim 9, wherein the perturbation log is transmitted outside of a computing device.

11. A neural network compression method comprising:
a first step of dividing a neural network into subgraphs; and
a second step of performing tentative compression by associating one compression technique selected from a plurality thereof with each of the subgraphs.

12. The neural network compression method according to claim 11, further comprising:
a third step of calculating a perturbation of a tentatively compressed neural network; and
a fourth step of changing a correspondence of compression techniques to the subgraphs based on the perturbation of the neural network.

13. The neural network compression method according to claim 11, further comprising:
a fifth step of calculating, for each of the subgraphs, a perturbation of the subgraph in units of tentatively compressed subgraphs; and
a sixth step of selecting a subgraph to be further divided based on the perturbation of the subgraph.

14. The neural network compression method according to claim 12, wherein
in the first step, a division method into the subgraphs is managed by an m-branch tree, and
the neural network is stored at a root of the m-branch tree, the neural network stored at the root of the m-branch tree is divided into m, m subgraphs are stored at a node of depth 1 that is a child of the root, and the subgraphs stored at leaves of the m-branch tree are output.

15. The neural network compression method according to claim 14, wherein a subgraph stored in a node having a largest perturbation among the m subgraphs stored in the node of depth 1 that is a child of the root is divided into m, and the subgraph is stored in a child of a node having the largest perturbation of the subgraphs.
